(19) United States
(12) Patent Application Publication
(10) Pub. No.: US 2006/0112754 A1
(43) Pub. Date: Jun. 1, 2006

(54) Method and device for correcting acceleration sensor axis information

(76) Inventors: Hiroshi Yamamoto, Shijyonawate-shi (JP); Shigeyuki Inoue, Kyotanabe-shi (JP); Shinji Tanaka, Ibaraki-shi (JP); Takako Shiraishi, Ikoma-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/542,016

(22) PCT Filed: Apr. 9, 2004
(86) PCT No.: PCT/JP04/05117

§ 371 Date: Jul. 11, 2005

(30) Foreign Application Priority Data
Nov. 4, 2003 (JP) 2003-108477

(51) Int. Cl. G01P 21/00

(52) U.S. Cl. 73/1.38

(57) ABSTRACT

The present device, which corrects parameters indicating the respective acceleration directions indicated by an acceleration sensor contained in a specific device, is comprised of: an acceleration sensing unit (11) that detects acceleration; an evaluation unit (12) that judges an action/posture, using patterns in changes in acceleration obtained from the acceleration sensor, when a person wearing the specific device acts; a parameter storage unit (15) that stores parameters to be used when the evaluation unit (12) makes a judgment; a correction trigger unit (31) that transmits, to the acceleration sensing unit (11) and an attachment position judgment unit (32), a signal indicating that parameter correction is to start, upon detection that the wearer or the like has pressed a correction trigger button; and a parameter correction unit (14) that reads out parameters stored in the parameter storage unit (15) based on a selection by the attachment position selection unit (13), and corrects the parameters in accordance with the attachment position so as to output the corrected parameters to the evaluation unit (12).

### TECHNICAL FIELD

The present invention relates to a device, with an acceleration sensor, for detecting an action/posture (bodily state) of a person, and particularly to a technique to correct parameters that indicate acceleration directions of the acceleration sensor.

### BACKGROUND ART

Against the backdrop that out society is aging, nursing care for the elderly is in the recent focus of attention. In particular, since it is deemed very important in nursing care to correctly grasp the actions of elderly people and dementia patients, a variety of techniques have been proposed to address it. Furthermore, it is also considered indispensable in nursing care to be available for means for tracking the action of the elderly or the like and for notifying the elderly himself/herself or another person such as caretaker of an abnormal action in case of occurrence. If the behavioral pattern of a person, whether such person is the elderly or not, can be grasped by measuring and analyzing the action/posture of such person, it becomes possible to control lighting and air conditioning for better comfort and more safe operations, and thus to provide a better living environment.

There is no reason to use such a measurement only for persons, and it is also effective to measure actions/operations and so forth of animals, machines, and others. For example, in the case of animals, the measuring of their actions can be utilized for research on their unknown life, whereas in the case of machines, the measuring of their state and operations is highly effective in terms of production activities, since it allows an efficient and safe running of the machines.

As methods for detecting an action/posture, techniques have been proposed to distinguish between resting state and moving state, conventionally using a pedometer, a mercury switch or the like. Meanwhile, recent years have seen the development of various advanced acceleration sensors and gyro sensors (angular acceleration sensors), and there have been proposed devices and methods utilizing such devices for detecting a walking state, an inclination of a body, a walking direction, or the like (for example, refer to Japanese Laid-Open Patent application No. 2002-119485 publication).

However, the above device has the following problem: since an output pattern of a sensor, which is a result of measuring an action/posture of a person being a measurement object, differs depending on attachment position on which the device is put, it is possible that an action or the like is misevaluated if the device is put on a position other than an attachment position that has been specifically determined for evaluation of the above action or the like.

The present invention has been conceived in view of the above problem, and it is an object of the present invention to provide a device and the like for correcting axis information of an acceleration sensor that is capable of correcting parameters indicating directions of the acceleration sensor that is equipped to a specific device attached to a moving object, said correction being made for evaluating an action/posture of the moving object in an accurate manner.

### DISCLOSURE OF INVENTION

In order to achieve the above object, an acceleration sensor axis information correction device that corrects a parameter indicating a direction of each acceleration indicated by an acceleration sensor that is included in a specific device attached to a moving object, the acceleration sensor axis information correction device including: a correction-related information obtainment unit that obtains correction-related information that relates to a correction of the parameter; and a correction unit that corrects the parameter based on the obtained correction-related information.

Furthermore, the acceleration sensor axis information correction device may further include a switch acceptance unit that accepts, from a user, a pressing of one of a plurality of switches indicating attachment positions of the specific device, wherein said correction-related information obtainment unit obtains, as the correction-related information, the accepted pressing of the button.

Accordingly, since a correction is performed on parameters indicating the respective acceleration directions in the acceleration sensor on the basis of the pressed switch, it is possible for the user to perform the parameter correction through a simple operation.

Furthermore, in order to achieve the above object, the acceleration sensor axis information correction device according to the present invention may further include: a collection unit that collects acceleration data of a predetermined action of the moving object; and a direction judgment unit that judges the direction of each acceleration based on the collected acceleration data, wherein said correction-related information obtainment unit obtains, as the correction-related information, the judged direction of each acceleration.

Accordingly, since the present device identifies the characteristics of changes in the acceleration data that has been collected for a predetermined action and performs the parameter correction based on such identified characteristics, it becomes possible to alleviate burdens on the user at the time of parameter correction.

Moreover, in order to achieve the above object, the acceleration sensor axis information correction device according to the present invention may further include a correction induction unit that determines timing at which the collection of the acceleration data should be started, based on a predetermined trigger, wherein said collection unit collects the acceleration data after the timing determined by said correction induction unit.

Accordingly, since the present device accepts a trigger (timing) for starting a correction, and the collection of acceleration data is started after the trigger is accepted, it becomes possible to stop acceleration data from being collected needlessly, allowing for a more efficient collection of acceleration data.

Furthermore, in order to achieve the above object, in the acceleration sensor axis information correction device according to the present invention, said correction induction unit may accept a speech, and use the accepted speech as the trigger.

Accordingly, since the present device allows the person wearing such device to give a speech instruction for starting a correction, it becomes possible for such person to perform necessary operations even when the device is attached on a position which is difficult for hands to operate. Thus, it becomes possible to avoid misoperations at the time of manual correction and thus to perform the correction in a correct manner.

Moreover, in the acceleration sensor axis information correction device according to the present invention, said correction induction unit may detect that the specific device has been attached onto the moving object, and use the detection as the trigger.

Accordingly, it becomes possible for the device to automatically detect if the wearer has put on/off the device, thereby prompting the wearer to perform a correction or automatically starting a correction, judging automatically whether a correction is needed or not.

Furthermore, in order to achieve the above object, in the acceleration sensor axis information correction device according to the present invention, said direction judgment unit may include: a storage unit that stores, in association with each other, the direction of each acceleration and information indicating characteristics of changes in the each acceleration, concerning walking of a person; and a comparison and judgment unit may (i) read out, from said storage unit, the information indicating the characteristics of changes in the each acceleration, and (ii) judge the direction of each acceleration by comparing characteristics of changes in acceleration indicated by the collected acceleration data with the characteristics indicated by the read-out information.

Accordingly, since the device provides an audio guidance as to a predetermined action that the wearer should perform, the user is required only to act according to such guidance, without needing to carry out any complicated user operations at the time of correction.

Moreover, in order to achieve the above object, the action/posture detection device according to the present invention is an action/posture detection device that has a function of correcting a parameter indicating a direction of each acceleration indicated by a self-contained acceleration sensor and that detects an action or a posture of a moving object, the device including: a correction-related information obtainment unit that obtains correction-related information that relates to a correction of the parameter; a correction unit that corrects the parameter based on the obtained correction-related information; a collection unit that collects acceleration data of an action of the moving object, using the acceleration sensor related to the corrected parameter; and a judgment unit that judges the action or posture of the moving object based on the collected acceleration data.

Accordingly, it becomes possible to alleviate burdens on the user at the time of correcting parameters indicating the respective directions in the acceleration sensors and therefore to avoid misoperations at the time of detecting an action/posture.

Note that in order to achieve the above object, it is also possible to embody the present invention as an acceleration sensor axis information correction method that includes, as its steps, the characteristic constituent elements of the above acceleration sensor axis information correction device and as a program including all of such steps. It should be also noted that such program can be stored in a ROM or the like included in the acceleration sensor axis information correction device and can be distributed on a recording medium such as CD-ROM and can be distributed via a transmission medium such as communication network.

Furthermore, it is also possible to embody the present invention as an action/posture detection device, with a function of the above acceleration sensor axis information correction device, for detecting an action or posture of a moving object and as an action/posture detection method which includes, as its steps the characteristic constituent elements of such device.

As described above, according to the acceleration sensor axis information correction device of the present invention, it is possible to appropriately perform parameter correction, even when the attachment position has changed, in accordance with such change as well as to prevent misoperations at the time of measuring an action or a posture.

### BRIEF DESCRIPTION OF DRAWINGS

FIG. 1 is a diagram showing an external view of an action/posture detection device according to a first embodiment.

FIG. 2 is a diagram showing an example construction of an acceleration sensor included in the action/posture detection device.

FIG. 3 is a block diagram showing a functional construction of the action/posture detection device according to the first embodiment.

FIG. 4 is a diagram showing a wearer wearing the action/posture detection device.

FIG. 5A is a diagram showing changes in parameters (meanings of the respective axes) in the case where the wearer attaches the action/posture detection device on the left side of the waist, the right side of the waist, the back, and the stomach.

FIG. 5B is a diagram showing an example meaning of each parameter in the case where the wearer attaches the action/posture detection device on the left side of the waist, the right side of the waist, the back, and the stomach.

FIG. 6 is a block diagram showing a functional construction of an action/posture detection device according to a second embodiment.

FIG. 7 is a flowchart showing a flow of operations performed by the action/posture detection device according to the second embodiment.

FIG. 8 is a block diagram showing a functional construction of an action/posture detection device according to a third embodiment.

FIG. 9 is a flowchart showing a flow of operations performed by an action/posture detection device according to the third embodiment.

FIG. 10 is a block diagram showing a functional construction of an action/posture detection device according to a fourth embodiment.

FIG. 11 is a flowchart showing a flow of operations performed by the action/posture detection device according to the fourth embodiment.

FIG. 12 is a block diagram showing a functional construction of an action/posture detection device according to a fifth embodiment.

FIG. 13 is a flowchart showing a flow of operations performed by the action/posture detection device according to the fifth embodiment.

FIG. 14 is a block diagram showing a functional construction of an action/posture detection device according to a sixth embodiment.

FIG. 15 is a diagram showing an example histogram distribution of acceleration data of the respective sensors when the wearer is walking.

FIG. 16 is a flowchart showing a flow of operations performed by the action/posture detection device according to the sixth embodiment.

### BEST MODE FOR CARRYING OUT THE INVENTION

The following provides detailed descriptions of embodiments of the present invention with reference to the drawings. Note that in the following embodiments, the present invention is described with reference to the drawings, but the present invention is not limited to them.

### First Embodiment

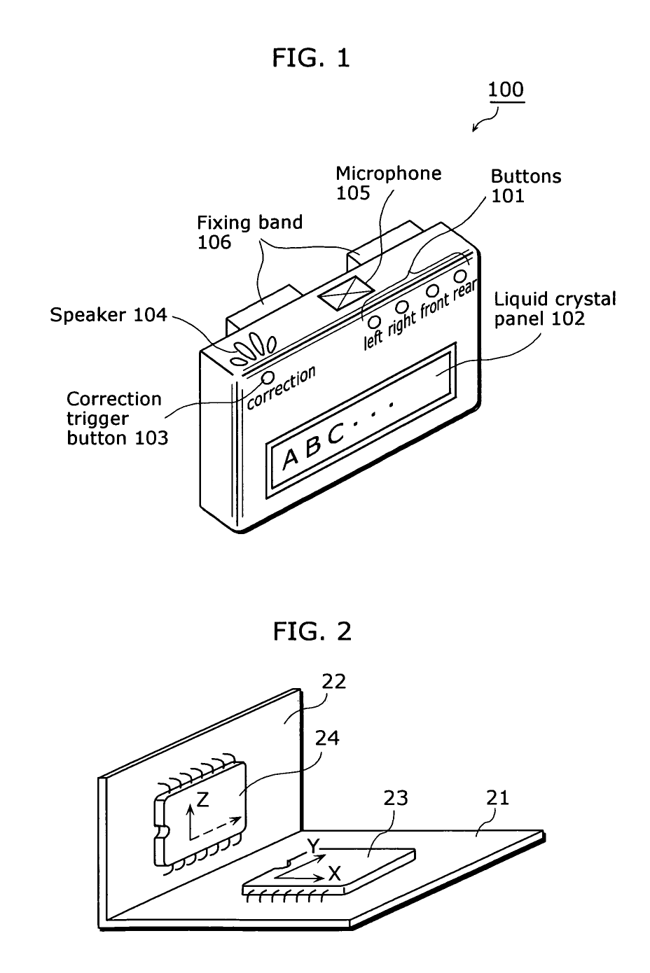

FIG. 1 is a diagram showing an external view of an action/posture detection device 100 according to the present embodiment. This action/posture detection device 100 is a device that identifies an action and a posture of a person wearing such device (hereinafter referred to as a “wearer”), using a built-in acceleration sensor. The present device, which has a relatively thin rectangular shape with the size of a business card (e.g. 5 cm in length, 8 cm in width, and 1.5 cm in thickness), is comprised of buttons 101, a liquid crystal panel 102, a correction trigger button 103, a speaker 104, and a microphone 105. Note that the action/posture detection device 100 includes a fixing band 106 or the like, thereby enabling a person to wear it (e.g. such person can wear the device on a belt).

The buttons 101 are pressed by the wearer or a user (caretaker) for confirming the position at which the device 100 has been attached. For example, when the device 100 has been attached on the left side of the waist of the wearer, “left” button is pressed down. Similarly, “right” button is pressed down when the device 100 has been attached on the right side of the waist of the wearer, “front” button is pressed down when the device 100 has been attached on the stomach, and “rear” button is pressed down when the device 100 has been attached on the lower part of the back of the wearer.

The liquid crystal panel 102 displays an operating mode of the device as well as an error message.

The correction trigger button 103 is pressed by the wearer or the like when parameter correction needs to be started in the device 100. Here, “parameter correction” refers to clarify a relationship between (i) directions of the respective acceleration sensors included in the device and (ii) a reference direction of the wearer (e.g. front serves as the reference direction of the wearer). Thus, the above correction needs to be performed every time the attachment position of the device changes.

The speaker 104 outputs an audio message to provide the user with a predetermined instruction at the time of parameter correction. The microphone 105 receives a spoken instruction from the user at the time of parameter correction.

FIG. 2 is a diagram showing an example construction of an acceleration sensor included in the action/posture detection device 100 shown in FIG. 1. As FIG. 2 shows, the acceleration sensor uses two 2-axis acceleration sensors, which enables the detection of 3-axis acceleration. Referring to FIG. 2, a detailed description is given of the present acceleration sensor. A circuit board 22 is fixedly placed vertically to a circuit board 21, and IC acceleration sensors 23 and 24 compliant with the same specification are placed on the respective boards. For example, the acceleration sensor 23 detects acceleration in the X axis and Y axis directions, whereas the acceleration sensor 24 detects acceleration in the Z axis direction. Thus, as shown in FIG. 2, the acceleration sensor 24 does not use an output in the other one axis (which is indicated by a broken line).

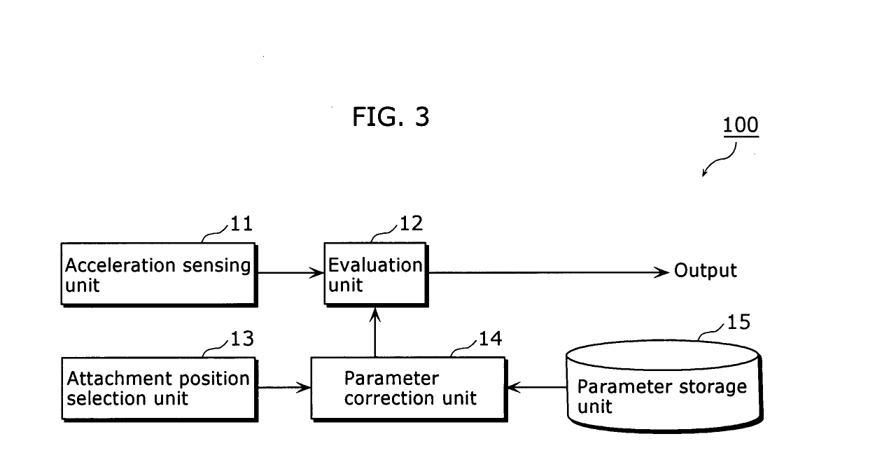

FIG. 3 is a block diagram showing a functional construction of the action/posture detection device 100 according to the present embodiment. As FIG. 3 shows, the action/posture detection device 100 is comprised of an acceleration sensing unit 11, an evaluation unit 12, an attachment position selection unit 13, a parameter correction unit 14, and a parameter storage unit 15.

The acceleration sensing unit 11 collects data indicating acceleration in the left and right direction, back and forth direction, and up and down direction in an action/posture of the wearer, and outputs the collected data to the evaluation unit 12.

The evaluation unit 12 evaluates the current action/posture of the wearer, on the basis of patterns in which acceleration in each direction changes. The following is an example of the above evaluation: it is evaluated as “walking” in the case where “acceleration data of the up and down direction shows, over a predetermined length of time, patterns in which large amplitude is observed at predetermined intervals; and it is evaluated that the wearer has “sit down” or “stood up” in the case where “acceleration data of both the up and down direction and back and forth direction first show changes in amplitude that are not periodic and include a momentarily big change and then acceleration data of all the directions show no big change for a certain period of time. Furthermore, it is also possible to evaluate changes in a posture (e.g. an inclination of the body after the wearer has sit down) of the wearer, on the basis of changes in acceleration of each of the directions. In the above evaluation, it is necessary to perform parameter correction that corresponds to the actual attachment position with respect to predetermined evaluation criteria, so as to improve the evaluation accuracy.

The attachment position selection unit 13, which corresponds to the buttons 101 shown in FIG. 1, includes a plurality of button switches that are associated with a plurality of candidate attachment positions. When the wearer or the like presses down, after determining an attachment position, a button switch corresponding to such determined attachment position, the attachment position selection unit 13 accepts such pressing of the button switch to confirm the attachment position, and sends, to the parameter correction unit 14, information indicating the confirmed attachment position.

When receiving, from the attachment position selection unit 13, the information indicating the attachment position, the parameter correction unit 14 reads, from the parameter storage unit 15, parameters used for evaluating an action/posture corresponding to the attachment position, and outputs them to the evaluation unit 12.

The parameter storage unit 15, which is a storage device made of a RAM or the like, stores parameters that are used by the evaluation unit 12 to evaluate actions/postures corresponding to a plurality of attachment position candidates as well as storing parameter-related information.

Note that, although not illustrated in FIG. 3, the device 100 is equipped with a control unit (e.g. a CPU having a ROM, a RAM, and the like) that controls timings or the like at which the respective units described above perform processing).

Next, parameters according to the present embodiment are described.

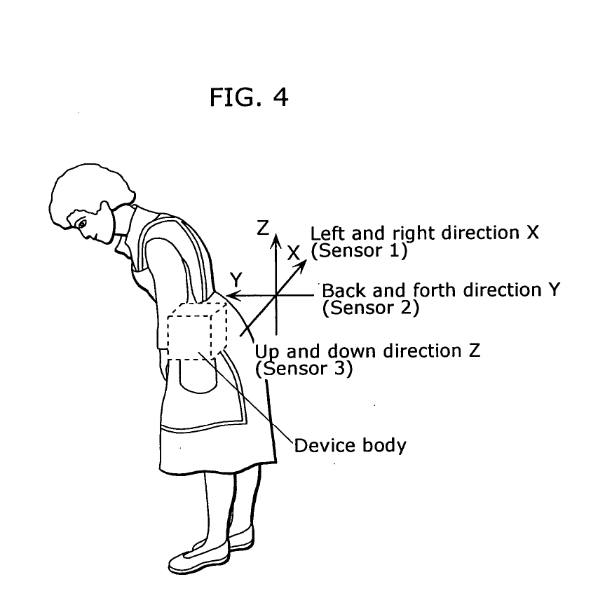

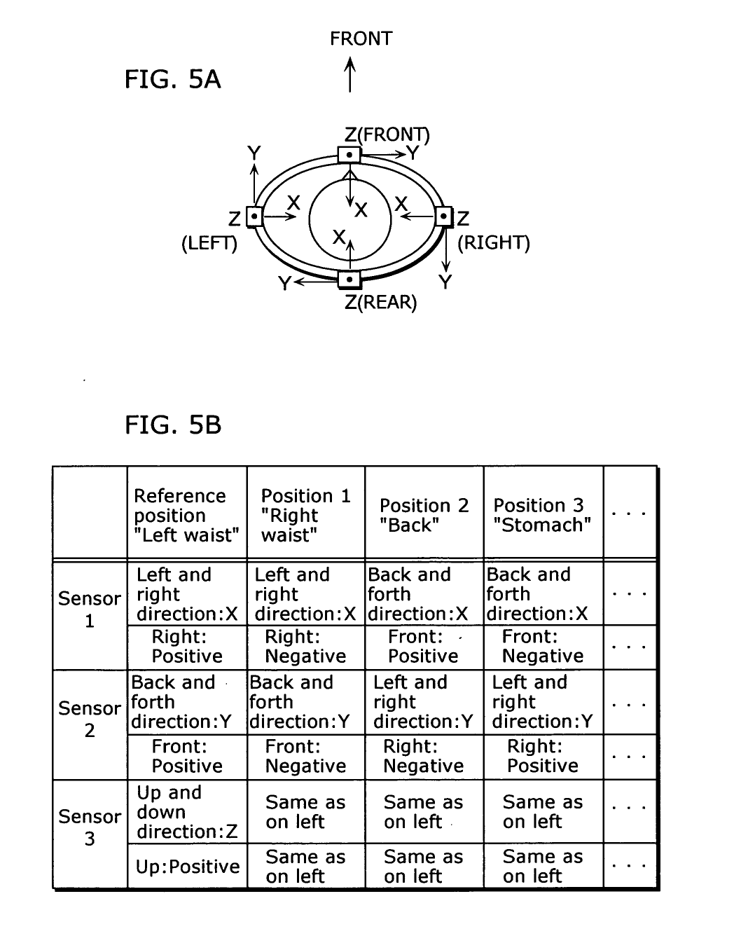

FIG. 4 is a diagram showing the wearer wearing the device 100. As FIG. 4 shows, in the case where the device 100 is attached on the left side of the waist of the wearer, the X axis, Y axis, and Z axis of the acceleration sensors shown in FIG. 2 indicate the left and right direction, back and forth direction, and up and down direction, respectively. In this case, when the wearer moves the attachment position of the device 100 to the stomach, the right side of the waist, or the back along the belt, the X axis and the Y axis of the acceleration sensor indicate different directions. Stated another way, in the case where the device 100 is attached onto the left side of the waist as shown in FIG. 5A, RIGHT indicates positive and LEFT indicates negative in the acceleration data of the X axis (the left and right direction), FRONT indicates positive and REAR indicates negative in the acceleration data of the Y axis (the back and forth direction), and UP indicates positive and DOWN indicates negative in the acceleration data of the Z axis (the up and down direction). Similarly, if the device 100 is attached onto the stomach, the right side of the waist, or the back, directions indicated by their respective X axis, Y axis, and Z axis differ.

FIG. 5B is a diagram showing an example meaning of each parameter (i.e. the meaning of a direction indicated by each of the three axes) in the case where the wearer attaches the device 100 onto the left side of the waist (reference position), the right side of the waist (position 1), the back (position 2), and the stomach (position 3).

Let us consider a relationship between the reference position (left side of the waist) and “position 1 (right side of the waist), in the case where the device 100 is attached on “position 1 (right side of the waist). In this case, the positive and negative of the left and right direction indicated by the sensor 1 (the X axis in FIG. 2) becomes reverse, and the positive and negative of the back and forth direction indicated by the sensor 2 (the Y axis) also becomes reverse. Next, let us consider a relationship with the reference position, in the case where the attachment position of the device 100 is “back”. In this case, the direction indicated by the sensor 1 changes from the left and right direction to the back and forth direction, and the direction indicated by the sensor 2 changes from the back and forth direction to the left and right direction.

As described above, in the action/posture detection device 100 according to the present invention, the parameter correction unit 14 reads out, based on a button pressed by the wearer or the like via the attachment position selection unit 13, parameters for an attachment position corresponding to such button from the parameter storage unit 15, and outputs them to the evaluation unit 12. The evaluation unit 12 evaluates an action/posture of the wearer, using the acceleration data inputted from the acceleration sensing unit 11 and the read-out parameters.

Note that in the present embodiment, parameters for the respective attachment positions are defined in tabular form, but it is also possible to represent, as equations, changes in parameters for the respective attachment positions.

As described above, the use of the action/posture detection device 100 according to the present embodiment makes it possible to prevent misevaluations of actions/postures through easy and simple operations, since the pressing of a button corresponding to the attachment position of the device 100 is accepted, and parameter correction is then performed on the basis of it.

### Second Embodiment

Descriptions have been given in the first embodiment that parameter correction is performed in response to a wearer's pressing of a button that corresponds to the attachment position, but in the present embodiment, acceleration data about a predetermined action pattern is collected after a correction trigger button is pressed down and parameter correction is performed by evaluating such acceleration data.

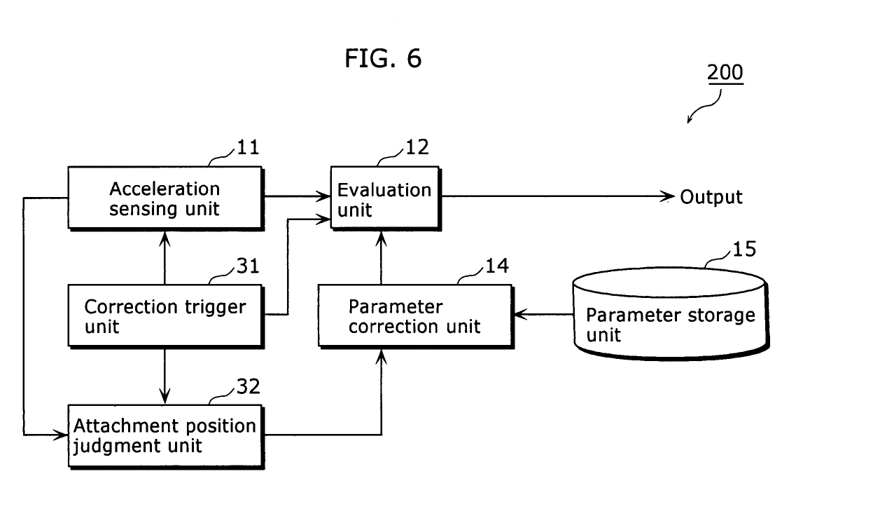

FIG. 6 is a block diagram showing a functional construction of an action/posture detection device 200 according to the present embodiment. The device 200 is comprised of an acceleration sensing unit 11, an evaluation unit 12, a parameter correction unit 14, a parameter storage unit 15, a correction trigger unit 31, and an attachment position judgment unit 32. In the following, functional elements that are the same as those of the first embodiment are assigned the same reference numbers, and descriptions thereof are omitted.

The trigger button 31 includes a button switch (e.g. it corresponds to the correction trigger button 103 shown in FIG. 1). When detecting that this button switch has been pressed by the wearer or the like, the correction trigger unit 31 sends, to the acceleration sensing unit 11 and the attachment position judgment unit 32, a signal indicating that parameter correction is to be started. The attachment position judgment unit 32, when receiving the signal from the correction trigger unit 31, evaluates acceleration data that has been inputted from the acceleration sensing unit 11 within a predetermined length of time (e.g. 15 seconds) so as to judge the attachment position of the device 200, and performs parameter correction on the basis of such judgment.

Note that, although not illustrated in FIG. 6, the device 200 is equipped with a control unit (e.g. a CPU having a ROM, a RAM, and the like) that controls timings or the like at which the respective units described above perform processing).

Next, a description is given of operations performed by the action/posture detection device 200 according to the present embodiment.

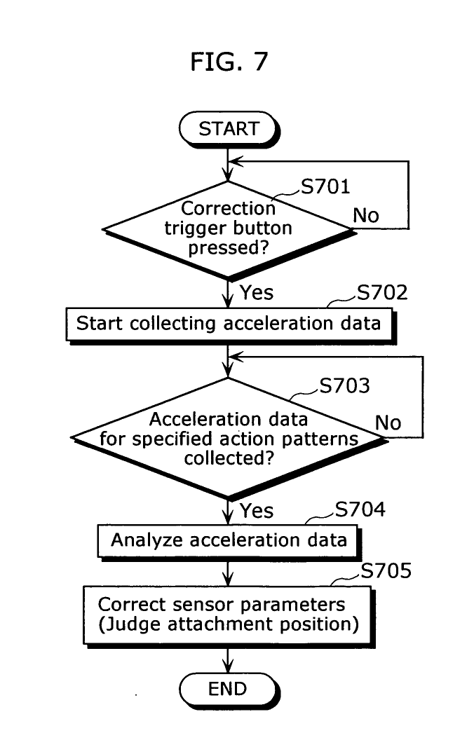

FIG. 7 is a flowchart showing the flow of operations performed by the device 200. Note that in the present device 200, an action pattern of the wearer at the time of correction is previously defined, and acceleration data is collected for such action pattern. For example, it is predetermined that the wearer should move toward right for five seconds after the button switch of the correction trigger unit 31 is pressed, and the wearer should move forward for the next five seconds.

First, when detecting that the button switch has been pressed down by the wearer (S701: Yes), the correction trigger unit 31 sends, to the acceleration sensing unit 11 and the attachment position judgment unit 32, a signal indicating that a correction is to be started.

In response to this, the acceleration sensing unit 11 collects acceleration data for 15 seconds after the button switch is pressed down (S702). After the acceleration data is collected (S703: Yes), the attachment position judgment unit 32 judges, on the basis of the collected acceleration data, directions indicated by the respective sensors (the X axis, Y axis, and Z axis) (S704). For example, in the case where values of the sensor 1 (the X axis) largely shift toward “positive” for the first five seconds and values of the sensor 2 (the Y axis) largely shift toward “positive” for the next five seconds, the attachment position judgments unit 32 judges that the device 200 is attached on the “left side of the waist”. Similarly, in the case where values of the sensor 2 (the Y axis) largely shift toward “negative” for the first five seconds and values of the sensor 1 (the X axis) largely shift toward “positive” for the next five seconds, the attachment position judgments unit 32 judges that the device 200 is attached on the “back”. Then, parameter correction is performed in accordance with the judged attachment position (S705).

Next, on the basis of the judgment made by the attachment position judgment unit 32, the parameter correction unit 14 reads out parameters from the parameter storage unit 15, as in the case of the first embodiment, and outputs them to the evaluation unit 12. The evaluation unit 12 evaluates an action/posture of the wearer based on the acceleration data inputted from the acceleration sensing unit 11 and on the parameters.

As described above, the use of the action/posture detection device 200 according to the present embodiment makes it possible to judge the attachment position based on a predetermined action of the wearer and to perform parameter correction based on such attachment position.

### Third Embodiment

Descriptions have been given in the aforementioned second embodiment that acceleration data for a predetermined action pattern is collected after the button switch (correction trigger button) is pressed and parameter correction is then performed by evaluating such acceleration data. In the present embodiment, descriptions are given for an embodiment in which: a predetermined audio guidance is provided to the wearer after the correction trigger button is pressed; then the wearer acts according to such audio guidance so that acceleration data is collected; and then parameter correction is performed as in the above case.

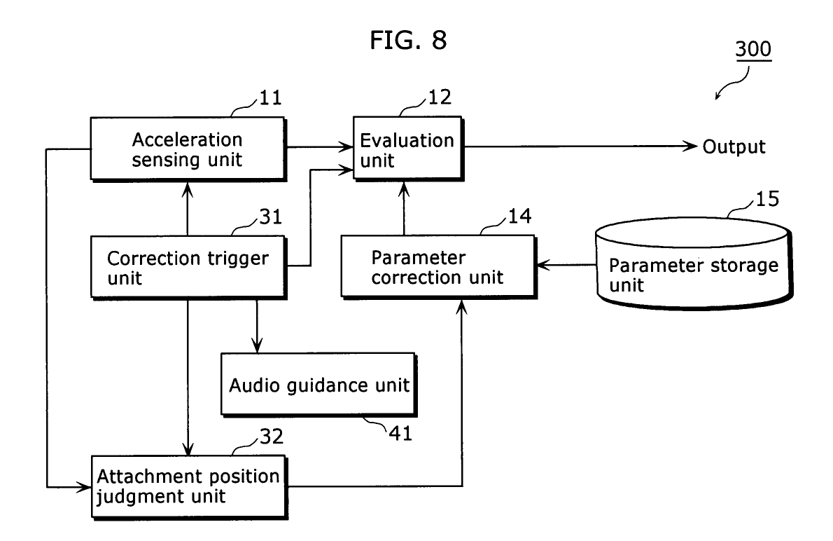

FIG. 8 is a block diagram showing the construction of an action/posture detection device 300 according to the present embodiment. The device 300 is comprised of an acceleration sensing unit 11, an evaluation unit 12, a parameter correction unit 14, a parameter storage unit 15, a correction trigger unit 31, an attachment position judgment unit 32, and an audio guidance unit 41. In the following, functional elements that are the same as those of the second embodiment are assigned the same reference numbers, and descriptions thereof are omitted.

When receiving, from the correction trigger unit 31, a signal indicating that parameter correction is to be started, the audio guidance unit 41 provides the wearer with an audio instruction so that the wearer performs a predetermined action that should be performed at the time of correction, as in the case of the second embodiment. For example, in the case where the above predetermined action is that the wearer should move toward right for five seconds after the button switch of the correction trigger unit 31 is pressed down and that the wearer should move forward for the next five seconds, the audio guidance unit 41 outputs an audio guidance such as the following: “First, move toward right. 1, 2, 3, 4, 5. Then, move forward. 1, 2, 3, 4, 5. Stop. It's finished now”.

Note that, although not illustrated in FIG. 8, the device 300 is equipped with a control unit (e.g. a CPU having a ROM, a RAM, and the like) that controls timings or the like at which the respective units described above perform processing).

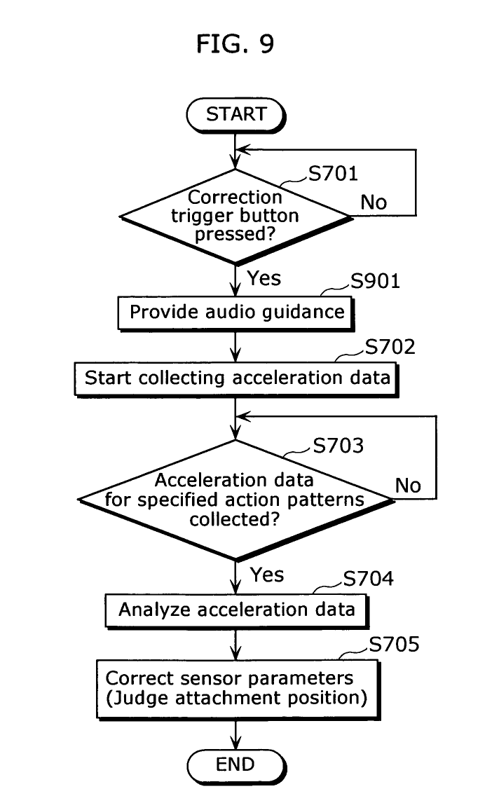

Next, descriptions are given of operations performed by the action/posture detection device 300 according to the present embodiment. FIG. 9 is a flowchart showing the flow of operations performed by the device 300.

First, when detecting that the button switch has been pressed down by the wearer (S701: Yes), the correction trigger unit 31 sends, to the acceleration sensing unit 11, the attachment position judgment unit 32, and the audio guidance unit 41, a signal indicating that a correction is to be started.

In response to this, the audio guidance unit 41 provides the wearer with an audio guidance so that the wearer performs a predetermined action (S901). Meanwhile, the acceleration sensing unit 11 collects acceleration data for 15 seconds after the button switch is pressed sown (S702). The subsequent processes are the same as those shown in FIG. 7 of the second embodiment (S703 to S705).

As described above, the use of the action/posture detection device 300 according to the present embodiment makes it possible to alleviate operation-related burdens on the wearer and to reduce the number of misoperations at the time of parameter correction, since the wearer is provided with an audio instruction (guidance) as to a predetermined posture/action that such wearer should take.

### Fourth Embodiment

Descriptions have been given in the aforementioned second embodiment that the pressing of the button switch (correction trigger button) is judged as an instruction for starting parameter correction, acceleration data for predetermined action patterns is then collected, and parameter correction is performed by evaluating such acceleration data. In the present embodiment, descriptions are given for an embodiment in which, instead of receiving the pressing of the button switch, the above instruction for starting parameter correction is received from the wearer as a spoken instruction.

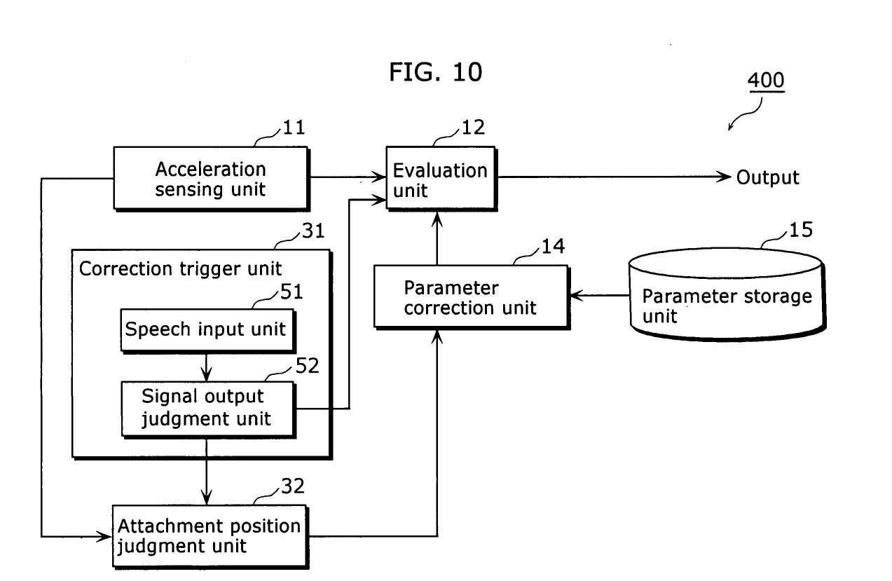

FIG. 10 is a block diagram showing a functional construction of an action/posture detection device 400 according to the present embodiment. The device 400 is comprised of an acceleration sensing unit 11, an evaluation unit 12, a parameter correction unit 14, a parameter storage unit 15, a correction trigger unit 31, and an attachment position judgment unit 32. Furthermore, the correction trigger unit 31 is made up of a speech input unit 51 and a signal output judgment unit 52. In the following, functional elements that are the same as those of the second embodiment are assigned the same reference numbers, and descriptions thereof are omitted.

The speech input unit 51 of the correction trigger unit 31 includes a microphone (which corresponds to the microphone 105 shown in FIG. 1) for converting a speech of the wearer into an electric signal, and outputs the speech of the wearer to the signal output judgment unit 52 as a signal waveform. When receiving a speech at or over a certain level of amplitude (or waveform) (e.g. “Start correction”), for example, the signal output judgment unit 52 judges that there is an input of an instruction for starting a correction, and outputs, to the attachment position judgment unit 32, a signal indicating that a correction is to be started. Here, the signal output judgment unit 52 may respond only to a specific speech by use of speech recognition processing or the like so as to reduce effects caused by peripheral noise.

Note that, although not illustrated in FIG. 10, the device 400 is equipped with a control unit (e.g. a CPU having a ROM, a RAM, and the like) that controls timings or the like at which the respective units described above perform processing).

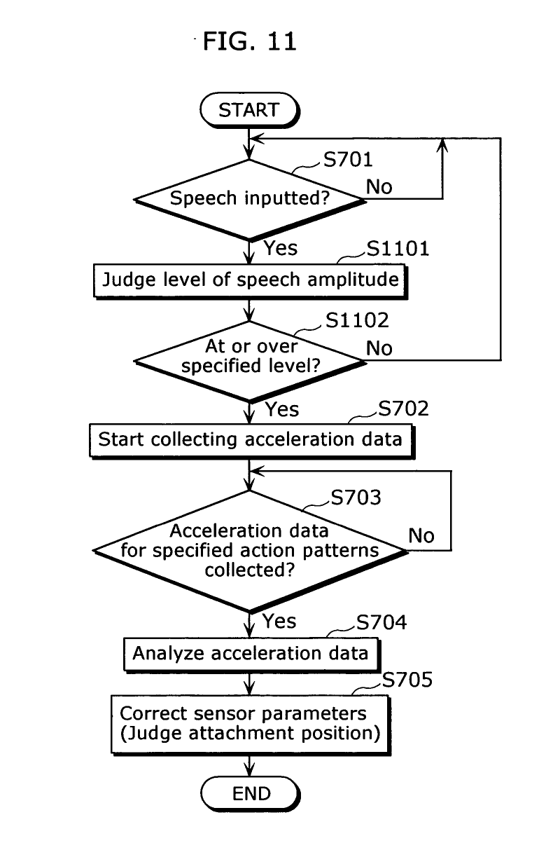

Next, descriptions are given of operations performed by the action/posture detection device 400 according to the present embodiment. FIG. 11 is a flowchart showing the flow of operations performed by the action/posture detection device 400.

First, when detecting that there is an input of a speech from the wearer (S701: Yes), the signal output judgment unit 52 judges whether or not it is an instruction for starting a correction, on the basis of the amplitude (or waveform) of such input speech (S1101). When it is at or over a specified level (S1102), the signal output judgment unit 52 sends, to the acceleration sensing unit 11 and the attachment position judgment unit 32, a signal indicating that a correction is to be started. The subsequent processes are the same as those shown in FIG. 7 of the second embodiment (S702 to S705).

As described above, the use of the action/posture detection device 400 according to the present embodiment makes it possible to facilitate operations to be carried out by the wearer and to reduce the number of misoperations at the time of parameter correction even when the device is attached at a position that is difficult for hands to operate such device, since it is possible to obtain a trigger for starting parameter correction from a speech of the wearer.

### Fifth Embodiment

Descriptions have been given in the third embodiment that a predetermined audio guidance is provided to the wearer after the button switch (correction trigger button) is pressed, and the wearer acts in accordance with such audio guidance so that acceleration data can be collected. In the present embodiment, instead of receiving the pressing of the button switch from the wearer, it is detected if the wearer has put the device on the body, and such detection is used as a trigger for starting a correction.

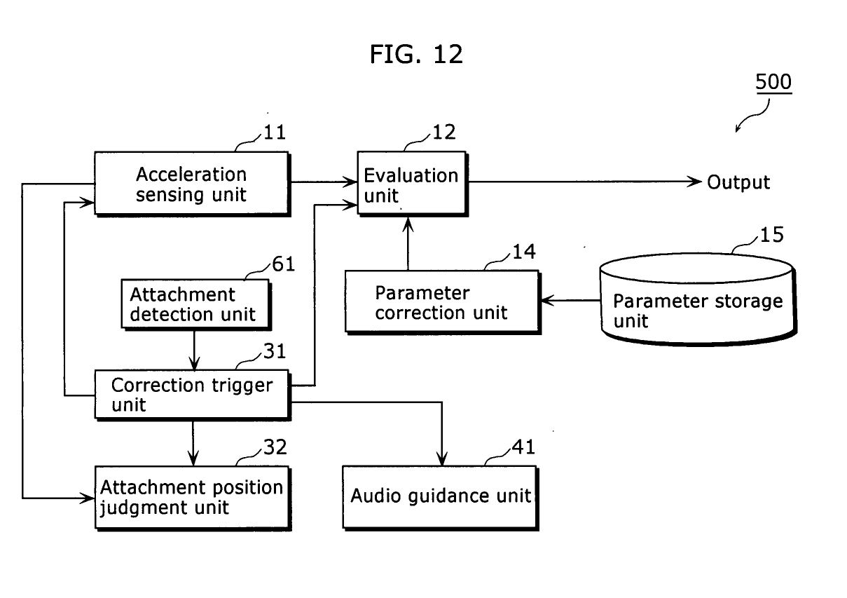

FIG. 12 is a block diagram showing the construction of an action/posture detection device 500 according to the present embodiment. The device 500 is comprised of an acceleration sensing unit 11, an evaluation unit 12, a parameter correction unit 14, a parameter storage unit 15, an attachment detection unit 61, a correction trigger unit 31, an attachment position judgment unit 32, and an audio guidance unit 41. In the following, functional elements that are the same as those of the third embodiment are assigned the same reference numbers, and descriptions thereof are omitted.

The attachment detection unit 61, which includes a contact switch placed on the side contacting the body of the wearer wearing the device 500, judges whether the device is being attached on the wearer or not, and sends a result of the judgment to the correction trigger unit 31.

The correction trigger unit 31 receives the judgment result from the attachment detection unit 61, and when a state changes from a non-attached state to an attached state, the correction trigger unit 31 judges that the attachment position has changed. Then, the correction trigger unit 31 sends, to the audio guidance unit 41, a signal indicating that a correction is to be started. When receiving the signal from the correction trigger unit 31, the audio guidance unit 41 provides the wearer with an audio instruction so that the wearer performs a predetermined action that should be performed at the time of correction, as in the case of the aforementioned third embodiment.

Note that, although not illustrated in FIG. 12, the device 500 is equipped with a control unit (e.g. a CPU having a ROM, a RAM, and the like) that controls timings or the like at which the respective units described above perform processing).

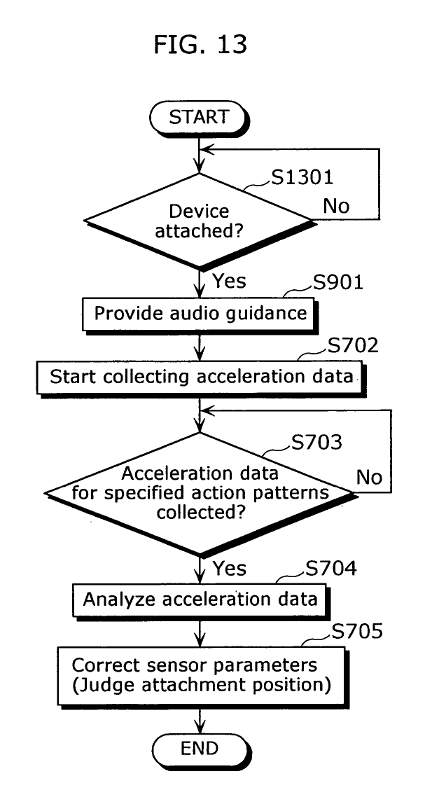

Next, a description is given of operations performed by the action/posture detection device 500 according to the present embodiment. FIG. 13 is a flowchart showing the flow of operations performed by the device 500.

First, when the attachment detection unit 61 detects that the device has been put on the wearer (S1301: Yes), the correction trigger unit 31 sends, to the acceleration sensing unit 11, the attachment position judgment unit 32, and the audio guidance unit 41, a signal indicating that a correction is to be started.

In response to this, the audio guidance unit 41 provides an audio guidance so that the wearer performs a predetermined action (S901). The subsequent processes are the same as those shown in FIG. 9 of the third embodiment (S702 to S705).

As described above, the use of the action/posture detection device 500 according to the present embodiment makes it possible to alleviate operation-related burdens on the wearer and to reduce the number of misoperations at the time of parameter correction, since the attachment position is judged to have been changed by automatically detecting the wearer's putting on/off of the device, thereby prompting the wearer to perform a correction or automatically starting a correction.

### Sixth Embodiment

Descriptions have been given in the fifth embodiment that a parameter correction is carried out on the basis of a predetermined action after it is detected that the wearer has put on the device. In the present embodiment, instead of performing a correction based on a specific action that is previously determined, a correction is performed based on an action pattern that is deemed most typical as an actual action of the wearer.

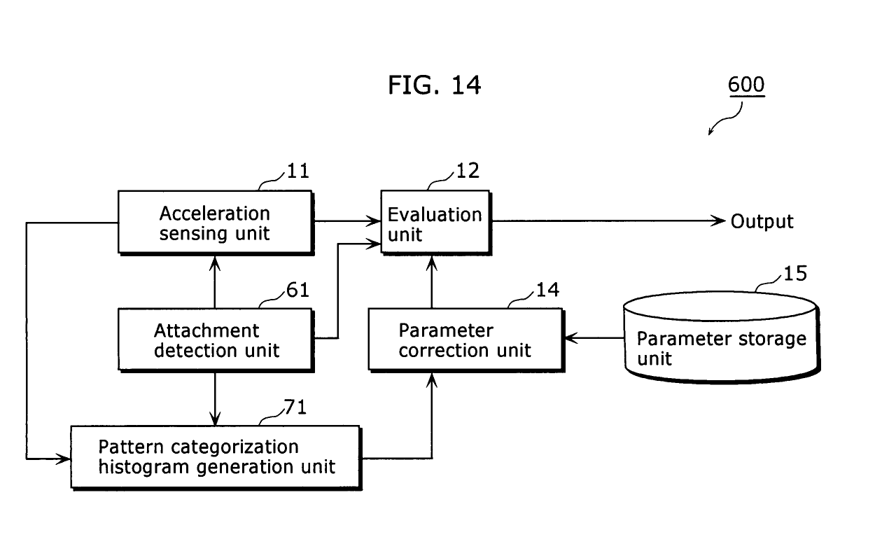

FIG. 14 is a block diagram showing a functional construction of an action/posture detection device 600 according to the present embodiment. The device 600 is comprised of an acceleration sensing unit 11, an evaluation unit 12, a parameter correction unit 14, a parameter storage unit 15, an attachment detection unit 61, and a pattern categorization histogram generation unit 71. In the following, functional elements that are the same as those of the fifth embodiment are assigned the same reference numbers, and descriptions thereof are omitted.

In the case where the pattern categorization histogram generation unit 71 receives, from the attachment detection unit 61, a signal indicating that the wearer has put on the device 600 and where at least one of the pieces of acceleration data of the respective directions inputted from the acceleration sensing unit 11 shows periodic patterns of change within a certain length of time that is determined in advance and shows no large variation, the pattern categorization histogram generation unit 71 samples the amplitudes of acceleration data and the number of the amplitudes per a certain length of time.

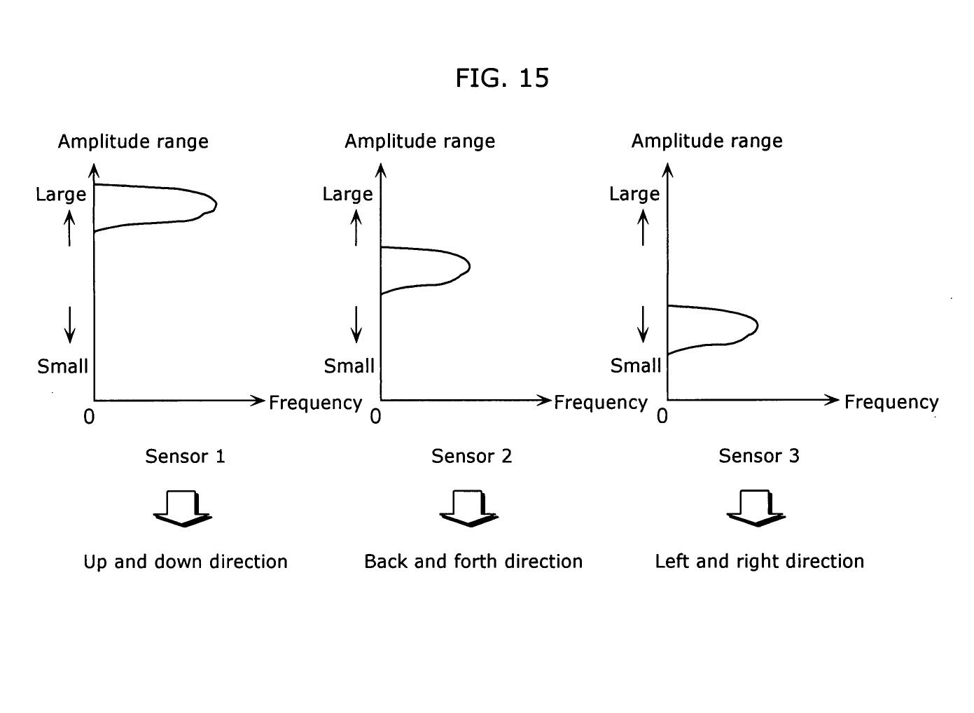

Furthermore, the pattern categorization histogram generation unit 71 judges which direction the sensor of each direction of the acceleration sensing unit 11 is currently associated, by use of the following: the direction of a sensor with the highest amplitude in the histogram distribution per a certain length of time as the up and down direction; the direction of a sensor with the next highest amplitude as the back and forth direction; and the direction of a sensor with the lowest amplitude as the left and right direction. This judgment is made on a certain assumption such as follows: “When a walking state of a person is considered, it is usual that the amplitude of acceleration in the up and down direction is the highest and shows a certain periodic pattern, that the amplitude of acceleration in the back and forth direction is the second highest, and that acceleration in the left and right direction is the lowest” and “It is usual that a person walks forward most of the time”. In an example shown in FIG. 15, for example, it is judges that the sensor 1 indicates the up and down direction since its amplitude range at the peak in the histogram distribution is largest, that the sensor 2 indicates the back and forth direction since its amplitude range is the second largest, and that the sensor 3 indicates the left and right direction since its amplitude range is the smallest.

Note that, although not illustrated in FIG. 14, the device 600 is equipped with a control unit (e.g. a CPU having a ROM, a RAM, and the like) that controls timings or the like at which the respective units described above perform processing).

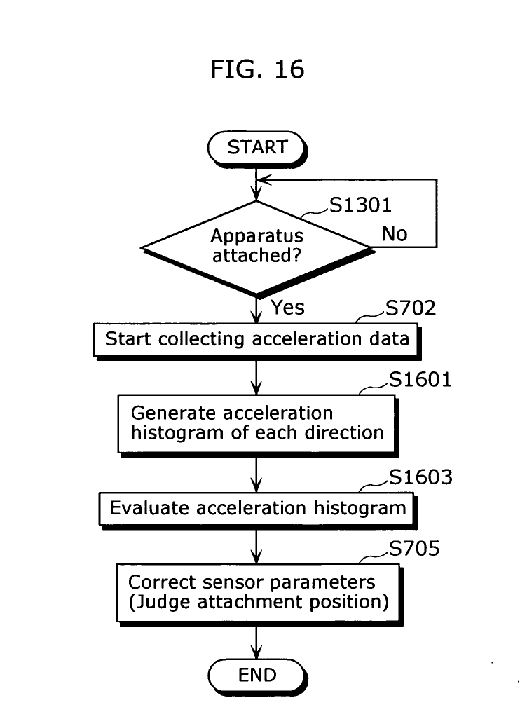

Next, a description is given of operations performed by the action/posture detection device 600 according to the present embodiment. FIG. 16 is a flowchart showing the flow of operations performed by the device 600.

First, when detecting that the device 600 has been put on the wearer (S1301: Yes), the attachment detection unit 61 sends, to the acceleration sensing unit 11 and the pattern categorization histogram generation unit 71, a signal indicating that a correction is to be started. In response to it, the acceleration sensing unit 11 starts collecting acceleration data (S702).

Then, the pattern categorization histogram generation unit 71 generates the above histograms based on the acceleration data collected by the acceleration sensing unit 11 (S1601) and judges whether the wearer is walking or not (S1602). When judging that the wearer is walking, the pattern categorization histogram generation unit 71 corrects parameters of the respective sensors (S705).

Note that when performing pattern categorization, the pattern categorization histogram generation unit 71 may compare not only each amplitude but also periodic times and may use a method utilizing frequency analysis such as Fourier transform, in order to further increase the accuracy.

As described above, the use of the action/posture detection device according to the present embodiment makes it possible to automatically perform parameter correction without requiring the wearer to perform special operations, since a correction is performed on the basis of an action that is deemed most typical as an action of the wearer in normal times.

### INDUSTRIAL APPLICABILITY

The present invention is applicable to a device that is equipped with an acceleration sensor for detecting an action, posture, or the like, the device being attached onto a moving object such as person, animal or the like.

1. An acceleration sensor axis information correction device that corrects a parameter indicating a direction of each acceleration indicated by an acceleration sensor that is included in a specific device attached to a moving object, the acceleration sensor axis information correction device comprising:
a correction-related information obtainment unit operable to obtain correction-related information that relates to a correction of the parameter; and
a correction unit operable to correct the parameter based on the obtained correction-related information.

2. The acceleration sensor axis information correction device according to claim 1, further comprising
a switch acceptance unit operable to accept, from a user, a pressing of one of a plurality of switches indicating attachment positions of the specific device,
wherein said correction-related information obtainment unit obtains, as the correction-related information, the accepted pressing of the button.

3. The acceleration sensor axis information correction device according to claim 1, further comprising:
a collection unit operable to collect acceleration data of a predetermined action of the moving object; and
a direction judgment unit operable to judge the direction of each acceleration based on the collected acceleration data,
wherein said correction-related information obtainment unit obtains, as the correction-related information, the judged direction of each acceleration.

4. The acceleration sensor axis information correction device according to claim 3, further comprising
a correction induction unit operable to determine timing at which the collection of the acceleration data should be started, based on a predetermined trigger,
wherein said collection unit collects the acceleration data after the timing determined by said correction induction unit.

5. The acceleration sensor axis information correction device according to claim 4,
wherein said correction induction unit accepts a speech, and uses the accepted speech as the trigger.

6. The acceleration sensor axis information correction device according to claim 4,
wherein said correction induction unit detects that the specific device has been attached onto the moving object, and uses the detection as the trigger.

7. The acceleration sensor axis information correction device according to claim 3, further comprising
an audio guidance unit operable to provide an audio guidance indicating details of the predetermined action.

8. The acceleration sensor axis information correction device according to claim 3,
wherein said direction judgment unit includes:
a storage unit operable to store, in association with each other, the direction of each acceleration and information indicating characteristics of changes in the each acceleration, concerning walking of a person; and
a comparison and judgment unit operable to (i) read out, from said storage unit, the information indicating the characteristics of changes in the each acceleration, and (ii) judge the direction of each acceleration by comparing characteristics of changes in acceleration indicated by the collected acceleration data with the characteristics indicated by the read-out information.

9. The acceleration sensor axis information correction device according to claim 8,
wherein said comparison and judgment unit judges that a direction related to acceleration showing a largest amplitude is an up and down direction, that a direction related to acceleration showing a second largest amplitude is a back and forth direction, and that a direction related to a smallest amplitude is a left and right direction.

10. An action/posture detection device that has a function of correcting a parameter indicating a direction of each acceleration indicated by a self-contained acceleration sensor and that detects an action or a posture of a moving object, the device comprising:
a correction-related information obtainment unit operable to obtain correction-related information that relates to a correction of the parameter;
a correction unit operable to correct the parameter based on the obtained correction-related information;
a collection unit operable to collect acceleration data of an action of the moving object, using the acceleration sensor related to the corrected parameter; and
a judgment unit operable to judge the action or posture of the moving object based on the collected acceleration data.

11. An acceleration sensor axis information correction method for correcting a parameter indicating a direction of each acceleration indicated by an acceleration sensor that is included in a specific device attached to a moving object, the method comprising:
obtaining correction-related information that relates to a correction of the parameter; and
correcting the parameter based on the obtained correction-related information.

12. An action/posture detection method for correcting a parameter indicating a direction of each acceleration indicated by a self-contained acceleration sensor and detecting an action or a posture of a moving object, the method comprising:
obtaining correction-related information that relates to a correction of the parameter;
correcting the parameter based on the obtained correction-related information;
collecting acceleration data of an action of the moving object, using the acceleration sensor related to the corrected parameter; and
judging the action or posture of the moving object based on the collected acceleration data.

13. A program for an acceleration sensor axis information correction device that corrects a parameter indicating a direction of each acceleration indicated by an acceleration sensor that is included in a specific device attached to a moving object, the program causing a computer to execute:
obtaining correction-related information that relates to a correction of the parameter; and
correcting the parameter based on the obtained correction-related information.

14. A program for an action/posture detection device that has a function of correcting a parameter indicating a direction of each acceleration indicated by a self-contained acceleration sensor and that detects an action or a posture, the program causing a computer to execute:
obtaining correction-related information that relates to a correction of the parameter;
correcting the parameter based on the obtained correction-related information;
collecting acceleration data of an action of a moving object, using the acceleration sensor related to the corrected parameter; and
judging the action or posture of the moving object based on the collected acceleration data.
